(19) United States
(12) Patent Application Publication
(10) Pub. No.: US 2011/0159724 A1
(43) Pub. Date: Jun. 30, 2011

(54) WIRE INSERTION AND CONNECTION STRUCTURE

(75) Inventors: GWUN-JIN LIN, TAOYUAN COUNTY (TW); KUO-FU SU, TAOYUAN COUNTY (TW); CHIH-HENG CHUO, TAOYUAN COUNTY (TW)

(73) Assignee: ADVANCED FLEXIBLE CIRCUITS CO., LTD., TAOYUAN COUNTY (TW)

(21) Appl. No.: 12/729,623

(22) Filed: Mar. 23, 2010

(30) Foreign Application Priority Data
Dec. 25, 2009 (TW) 98144992

(51) Int. Cl. H01R 12/24

(52) U.S. Cl. 439/492

(57) ABSTRACT

A wire insertion and connection structure includes a plurality of wires that extends in a substantially parallel manner. Each wire includes a conductor and an insulation layer enclosing the conductor. Each wire has an end forming an insertion end, and each conductor has a portion exposed outside the respective insertion end to form a conductive engagement section. The insertion ends of the wires are coupled to an insertion assisting unit. The insertion assisting unit forms a plurality of positioning slots, which is distributed in a surface of the insertion assisting unit in a substantially parallel manner and spaced from each other by insulation sections. The conductive engagement sections of the conductors are respectively positionable in the positioning slots, whereby when the insertion ends of the wires and the insertion assisting unit are inserted into a receiving compartment defined in a connector, the conductive engagement sections of the conductors of the wires are respectively positioned on and engaging metal conductive elements received and set inside the receiving compartment of the connector.

### FIELD OF THE INVENTION

The present invention relates to the design of insertion and connection structure, and in particular to a wire insertion and connection structure for insertion into a connector.

### BACKGROUND OF THE INVENTION

Connectors are commonly used in circuits of for example electrical appliances, electronic devices, and computer facilities for transfer of signals. Due to the trend of light-weight and compactness, both electronic components and signal cables are subjected to a progressive change of reducing size and volume. In regard to the development of signal cables, flat cables have been widely used in various electronic products. Types of flat cables include flexible circuit boards, which are made by flexible printed circuited board technology, and flexible flat cables (FFC), which are formed by bonding a plurality of juxtaposing wires together.

Practical applications of the flat cables that are formed by bonding a plurality of juxtaposing wires in transferring signals requires connectors for connecting the cables. For example, various consumer electronic devices, including notebook computers, liquid crystal displays, digital cameras, mobile phones, and touch panels, are constructed to comprise a cover or a screen that is separate from a device body and transfer of signals is necessary between the two. In these applications, connectors are used for connection of signal.

### SUMMARY OF THE INVENTION

However, in practical applications of the conventional connectors, a plurality of metal conductive elements are received and fixed in a receiving compartment defined in the connector to establish engagement with a plurality of wires of a flat cable. Due to the trend of light weight and compactness, the size and volume of the connector are reduced, whereby the spacing between adjacent ones of the metal conductive elements inside the connector gets very small and the width of portion of each metal conductive element engageable with a wire is also very narrow. When the wires of a flat cable have conductive engagement sections that are of a size close to or even greater than the width of the engagement portions of the metal conductive elements, any tiny shift in position between the connector and the flat cable would result in incorrect engagement between the conductive engagement sections of the wires of the flat cable and the engagement portions of the metal conductive elements of the connector and eventually lead to poor conduction or even shorting during the transfer of signals.

Thus, an objective of the present invention is to provide a wire insertion and connection structure, which comprises an insertion assisting unit to be coupled to insertion ends of wires to ensure excellent connected relationship between a connector and a flat cable comprising a plurality of wires so as to overcome the problem of poor insertion occurring in an operation of insertion of conventional wires.

Another objective of the present invention is to provide a wire insertion and connection structure, which comprises a plurality of positioning slots defined in a receiving compartment of a connector and spaced from each other by insulation sections so as to allow for excellent connection realized between the connector and a flat cable composed of a plurality of wires.

The solution adopted in the present invention to overcome the problems of the conventional techniques comprises a wire insertion and connection structure, which comprises a plurality of wires that extends in a substantially parallel manner. Each wire comprises a conductor and an insulation layer enclosing the conductor. An end of the wire serves as an insertion end and a portion of a respective conductor is exposed outside the insertion end to serve as a conductive engagement section.

An insertion assisting unit is coupled to the insertion ends of the wires. The insertion assisting unit forms a plurality of positioning slots that are defined on a surface of the insertion assisting unit in a substantially parallel manner and spaced from each other by insulation sections. The conductive engagement sections of the wires are respectively received in the positioning slots. When the insertion ends of the wires and the insertion assisting unit are inserted into a receiving compartment defined in a connector, the conductive engagement sections of the wires are positioned on and set in engagement with metal conductive elements retained in the receiving compartment of the connector.

Each of the metal conductive elements retained in the receiving compartment of the connector forms a projection. When the insertion ends of the wires and the insertion assisting unit are inserted into the receiving compartment of the connector, the conductive engagement sections of the conductors of the wires are positioned on the projections of the metal conductive elements.

In another preferred embodiment, a plurality of wires that extends in a substantially parallel manner is provided and has insertion ends insertable into a receiving compartment of a connector. The receiving compartment of the connector defines a plurality of positioning slots, which is defined in a surface of the receiving compartment of the connector in a substantially parallel manner and spaced from each other by insulation sections. Metal conductive elements are respectively received in the positioning slots and each forms a projection. When the insertion ends of the wires are inserted into the corresponding position slots of the connector, conductive engagement sections of conductors of the wires are respectively positioned on and engaging the projections of the metal conductive elements.

With the solution provided by the present invention, an insertion assisting unit is provided as an intermediate medium for establishing engagement between a plurality of wires that extends in a substantially parallel manner and a connector. The insertion assisting unit forms a plurality of positioning slots that are spaced from each other by insulation sections to respectively receive conductive engagement sections of conductors of the wires therein, whereby the wires received in the positioning slots are isolated from each other by the insulation sections. This solution helps improving the problem of incorrect engagement between the conductive engagement sections of the wires and the corresponding metal conductive elements of the connector caused by undesired positional shift occurring between a conventional connector and a flat cable, and thus overcomes the drawback of poor conduction or shorting during transfer of signals.

The structure of the insertion assisting unit can be directly applied to a receiving compartment of a connector that receives and retains therein metal conductive elements. The receiving compartment of the connector forms a plurality of positioning slots that is substantially parallel to and spaced from each other by insulation sections. Thus, the wires received in the positioning slots are isolated from each other by the insulation sections, whereby poor conductor or even shorting occurring during transfer of signal caused by incorrect engagement occurring when insertion ends of conventional wires are directly inserted into the receiving compartment of the connector can be eliminated.

Further, the wire insertion and connection structure according to the present invention allows the conductors or wires to be directly positioned in the positioning slots, which offers the advantage of easy and labor-saving operation, so as to make is applicable to the connection between connectors and wires of various electronic devices.

### BRIEF DESCRIPTION OF THE DRAWINGS

The present invention will be apparent to those skilled in the art by reading the following description of preferred embodiments of the present invention, with reference to the attached drawings, in which:

FIG. 1 is an exploded view of a first embodiment of the present invention;

FIG. 2 is a perspective view of the first embodiment of the present invention;

FIG. 3 shows wires, an insertion assisting unit, and a connector, which are detached from each other, in accordance with the first embodiment of the present invention;

FIG. 4 is a perspective view showing the wires and the insertion assisting unit according the first embodiment of the present invention coupled to the connector;

FIG. 5 is a cross-sectional view taken along line 5-5 of FIG. 3;

FIG. 6 is a cross-sectional view taken along line 6-6 of FIG. 4;

FIG. 7 is a cross-sectional view of a second embodiment in accordance with the present invention;

FIG. 8 is an exploded view of a third embodiment of the present invention; and

FIG. 9 is a cross-sectional view illustrating wires received in a connector in accordance with the third embodiment of the present invention.

### DETAILED DESCRIPTION OF THE PREFERRED EMBODIMENTS

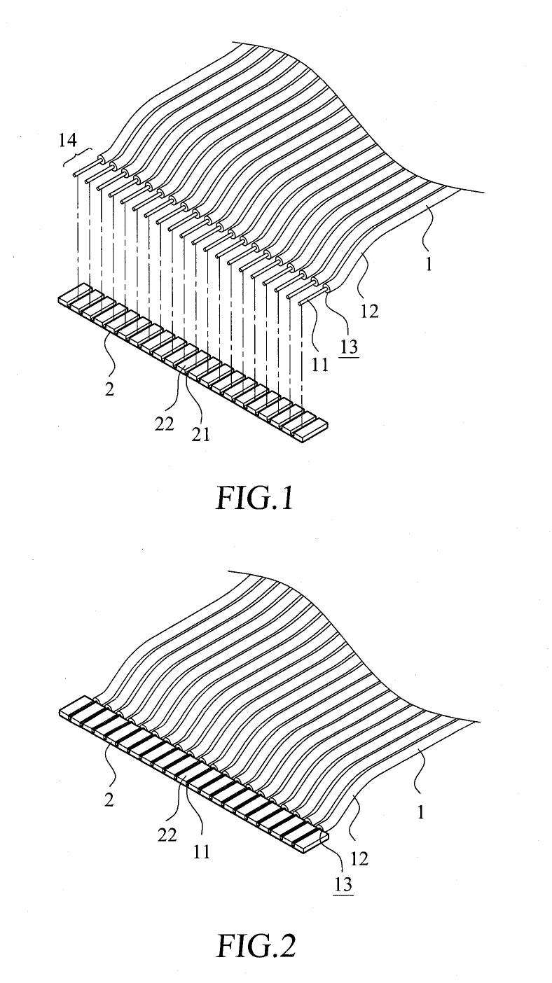

With reference to the drawings and in particular to FIGS. 1 and 2, FIG. 1 shows an exploded view of a first embodiment of the present invention and FIG. 2 shows a perspective view of the first embodiment of the present invention. The present invention provides a wire insertion and connection structure, which is applied to a plurality of wires 1 that extends in a mutually parallel manner. The wires 1 can be arranged to juxtapose each other so as to construct a flat cable, or alternatively the wires 1 can be separate from each other. Each of the wires 1 comprises a conductor 11 and an insulation layer 12 enclosing the conductor 11. As shown, each of the wires 1 has an end that serves as an insertion end 13, and each of the conductors 11 has a portion exposed outside the respective insertion end 13 to form a conductive engagement section 14.

In the instant embodiment, the insertion ends 13 of the wires 1 are coupled to an insertion assisting unit 2. The insertion assisting unit 2 forms a plurality of positioning slots 21, which are distributed in a surface of the insertion assisting unit 2 in a mutually parallel manner. Adjacent positioning slots 21 are spaced from each other by an insulation section 22. The conductive engagement sections 14 of the conductors 11 are respectively received in the positioning slots 21.

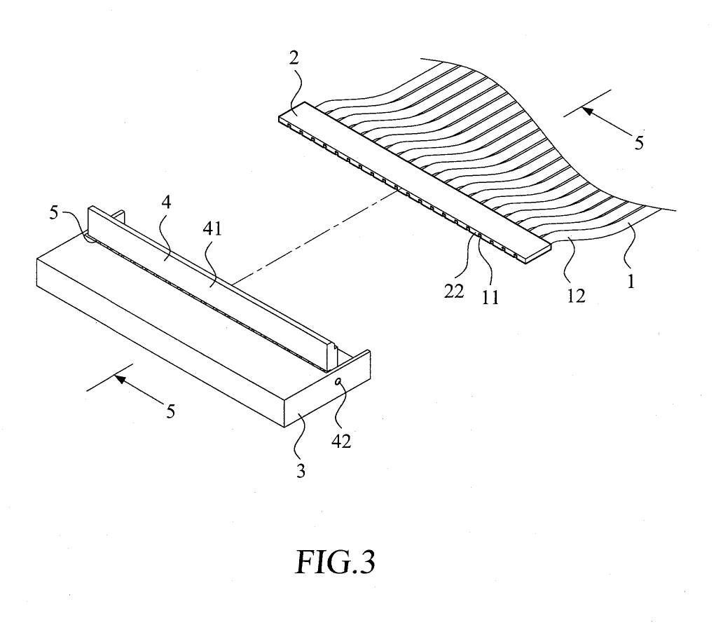

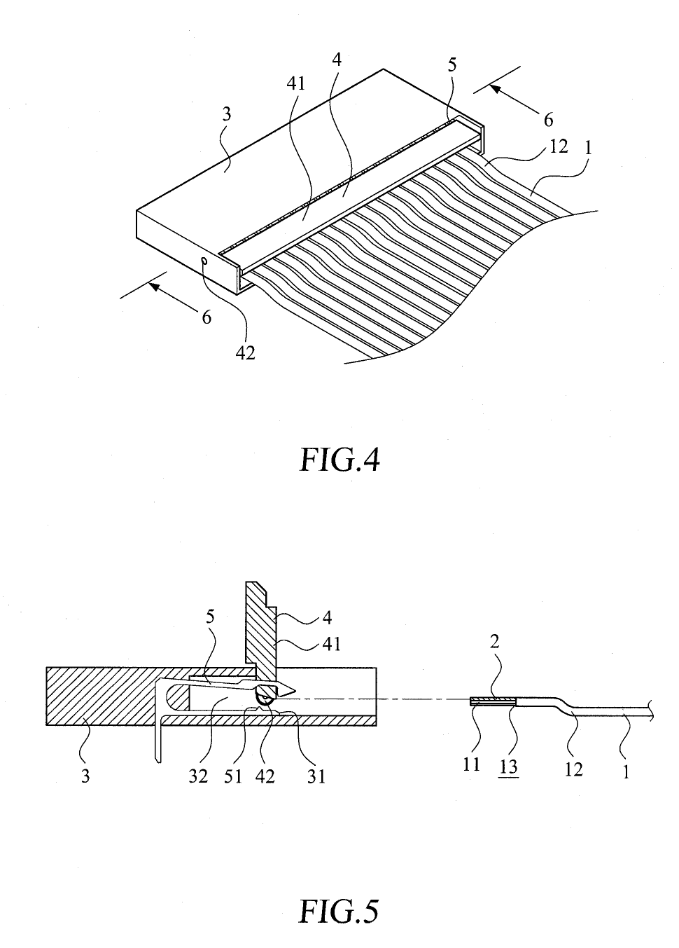

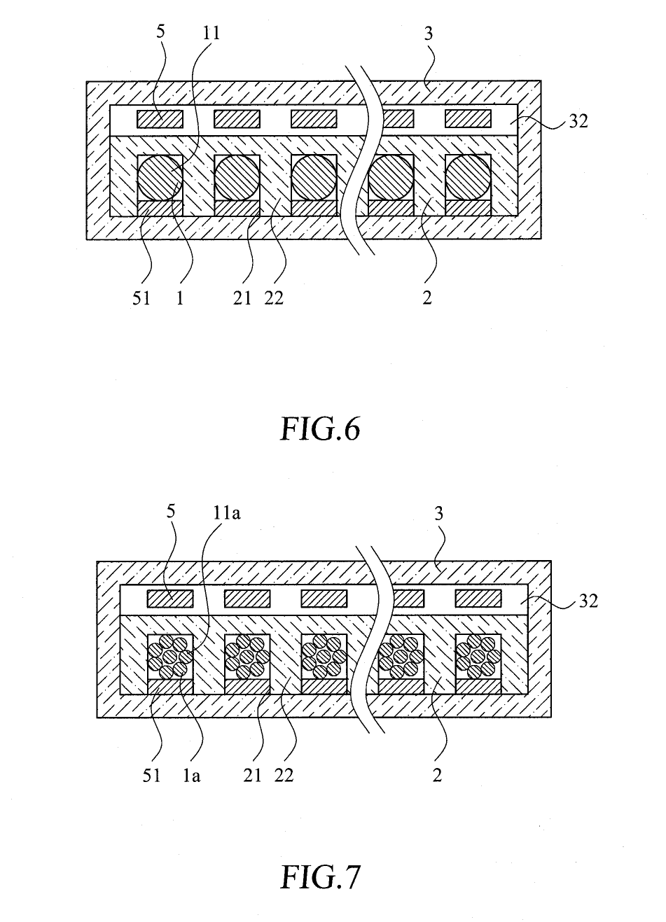

Referring to FIGS. 3-6, FIG. 3 shows the wires, the insertion assisting unit, and a connector, which are detached from each other, in accordance with the first embodiment of the present invention; FIG. 4 is a perspective view showing the wires and the insertion assisting unit according the first embodiment of the present invention coupled to the connector; FIG. 5 is a cross-sectional view taken along line 5-5 of FIG. 3; and FIG. 6 is a cross-sectional view taken along line 6-6 of FIG. 4.

With the insertion ends 13 of the wires 1 coupled to the insertion assisting unit 2, the insertion ends 13 of the wires 1 and the insertion assisting unit 2 are insertable and thus coupled to a connector 3. Those having ordinary skills in the art realize that the connector 3 can be constructed in such a way that the connector forms a wire insertion opening 31 and a receiving compartment 32, and further a zero-insertion-force coupling structure 4 can be optionally provided at a position corresponding to the wire insertion opening 31 of the connector 3. The zero-insertion-force coupling structure 4 can be of a known structure, which comprises, for example, a liftable hold-down member 41 and two pivot structures 42 that pivotally connect the hold-down member 41 to opposite sidewalls of the connector 3 to allow the hold-down member 41 to be lifted for opening and thus receiving the insertion of the insertion ends 13 of the wires 1 into wire insertion opening 31 with a zero insertion force.

The receiving compartment 32 of the connector 3 comprises a plurality of metal conductive elements 5 received therein. The metal conductive elements 5 are arranged inside the connector 3 in a horizontally set and spaced manner. Each of the metal conductive elements 5 received in the receiving compartment 32 forms a projection 51. When the insertion ends 13 of the wires 1 and the insertion assisting unit 2 are inserted into the receiving compartment 32 of the connector 3, the positioning slots 21 of the insertion assisting unit 2 are arranged to face downward and respectively oppose the metal conductive elements 5, and the conductive engagement sections 14 of the conductors 11 of the wires 1 are respectively positioned on the projections 51 to realize connection between the conductors 11 of the wires 1 and the metal conductive elements 5 and the projections 51. In the instant embodiment, each of the wires 1 comprises a single conductor core lead.

Referring to FIG. 7, a cross-sectional view of a second embodiment in accordance with the present invention is shown. In the second embodiment, the wire insertion and connection structure comprises substantially the same components as those of the first embodiment and same components carry the same reference numeral for correspondence. The difference between the two embodiments is that for practicability of application, the second embodiment is applied to wires, which are designated with reference numeral 1a for distinction, and the wire 1a are of a structure comprising a multiple-core conductor 11a. Again, when the insertion ends 13 of the wires 1a, together with the insertion assisting unit 2, are inserted into a receiving compartment 32 defined in a connector, the positioning slots 21 of the insertion assisting unit 2 are arranged to face downward and respectively oppose metal conductive elements 5 received in the connector and the conductive engagement sections 14 of the multiple-core conductors 11a of the wires 1a are respectively positioned on and engaging the projections 51 to realize connection between the conductors 11a of the wires 1a and the metal conductive elements 5 and the projections 51.

In a practical application, before the multiple-core conductors 11a are mounted to the positioning slots 21 of the insertion assisting unit 2, the conductors 11a can be first applied with solders or other conductive and adhesive substances to have the multiple cores of each conductor 11a bonded together without separation after being held down.

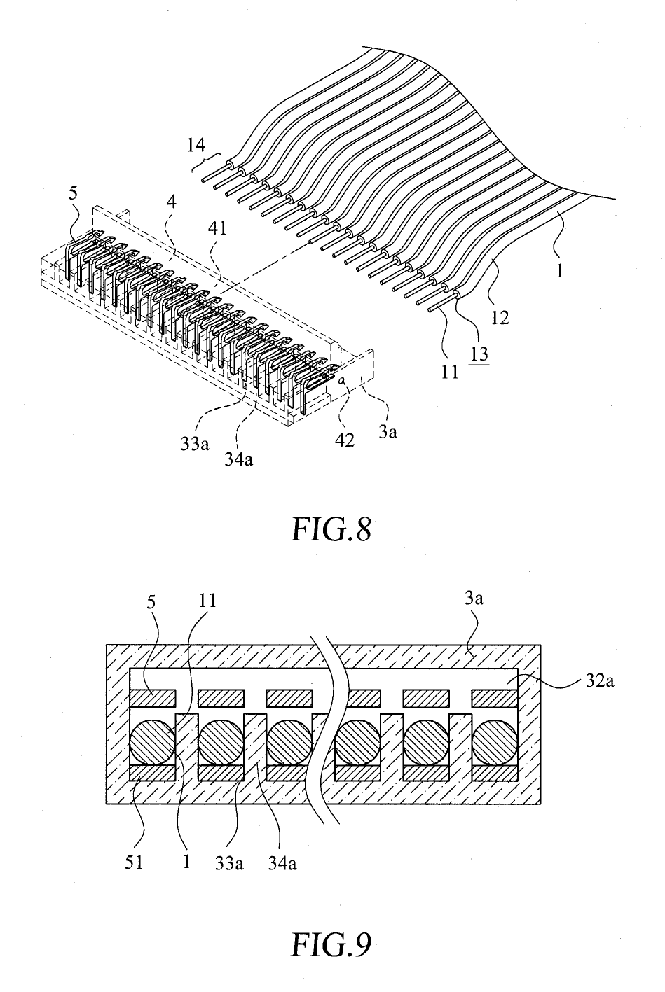

Referring to FIGS. 8 and 9, FIG. 8 shows an exploded view of a third embodiment of the present invention and FIG. 9 is a cross-sectional view illustrating wires received in a connector in accordance with the third embodiment of the present invention. In the third embodiment, a plurality of wires 1, which are arranged to extend in a mutually parallel manner, are respectively insertable into a receiving compartment 32a of a connector 3a. The receiving compartment 32a of the connector 3a forms therein a plurality of positioning slots 33a which are distributed on a surface of the receiving compartment 32a of the connector in a mutually parallel manner and spaced from each other by an insulation section 34a. The positioning slots 33a respectively receive metal conductive element 5 therein.

When the insertion ends 13 of the wires 1 are inserted through a wire insertion opening of the connector 3a into the receiving compartment 32a, the conductive engagement sections 14 of the conductors 11 of the wires 1 are respectively positioned on and engaging projections 51 formed on the metal conductive elements 5 so as to realize connection between the conductors 11 of the wires 1 and the metal conductive element 5 and the projections 51.

Apparently, those having ordinary skills in the art may realize that besides using an insertion assisting unit to couple wires to a connector, the present invention alternatively uses a plurality of positioning slots that form inside a connector and spaced by insulation sections to allow wires to be set in respective engagement with metal conductive elements received in the positioning slots, so that the configuration of the connector shown in the third embodiment is just one of a number of feasible configurations that the present invention can take and for all variations that can be made in the connector for receiving wires therein are believed to belong to the scope of the present invention as defined in the following claims.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A wire insertion and connection structure, comprising a plurality of wires that extends in a substantially parallel manner, each of the wires comprising a conductor and an insulation layer enclosing the conductor, the wires having an end forming an insertion end, each of the conductors having a portion exposed outside the respective insertion end to form a conductive engagement section, characterized in that the insertion ends of the wires are coupled to an insertion assisting unit, and the insertion assisting unit forms a plurality of positioning slots which are distributed on a surface of the insertion assisting unit in a substantially parallel manner and spaced from each other by insulation sections, the conductive engagement sections of the conductors being respectively positionable in the positioning slots, whereby when the insertion ends of the wires and the insertion assisting unit are inserted into a receiving compartment defined in a connector, the conductive engagement sections of the conductors of the wires are respectively positioned on and engaging metal conductive elements received and set inside the receiving compartment of the connector.

2. The wire insertion and connection structure as claimed in claim 1, wherein each of the plurality of wires comprises a single-core structure.

3. The wire insertion and connection structure as claimed in claim 1, wherein each of the plurality of wires comprises a multiple-core structure.

4. The wire insertion and connection structure as claimed in claim 1, wherein the plurality of the wires are arranged to juxtapose each other to form a flat cable.

5. The wire insertion and connection structure as claimed in claim 1, wherein the plurality of wires are separate from each other.

6. The wire insertion and connection structure as claimed in claim 1, wherein each of the metal conductive elements received in the receiving compartment of the connector forms a projection, whereby when the insertion ends of the wires and the insertion assisting unit are inserted into the receiving compartment of the connector, the conductive engagement sections of the conductors of the wires are respectively positioned on the projections of the metal conductive elements.

7. A wire insertion and connection structure, comprising a plurality of wires that extends in a substantially parallel manner, each of the wires comprising a conductor and an insulation layer enclosing the conductor, the wires having an end forming an insertion end, each of the conductors having a portion exposed outside the respective insertion end to form a conductive engagement section, the insertion ends of the wires being insertable into a receiving compartment defined in a connector, characterized in that the receiving compartment of the connector forms therein a plurality of positioning slots, which are distributed on a surface of the receiving compartment of the connector in a substantially parallel manner and spaced from each other by insulation sections, metal conductive elements being respectively received in the positioning slots, whereby when the insertion ends of the wires are inserted into the receiving compartment of the connector, the conductive engagement sections of the conductors of the wires are respectively set in engagement with the metal conductive elements of the receiving compartment of the connector.

8. The wire insertion and connection structure as claimed in claim 7, wherein each of the plurality of wires comprises a single-core structure.

9. The wire insertion and connection structure as claimed in claim 7, wherein each of the plurality of wires comprises a multiple-core structure.

10. The wire insertion and connection structure as claimed in claim 7, wherein the plurality of the wires are arranged to juxtapose each other to form a flat cable.

11. The wire insertion and connection structure as claimed in claim 7, wherein the plurality of wires are separate from each other.

12. The wire insertion and connection structure as claimed in claim 7, wherein each of the metal conductive elements received in the receiving compartment of the connector forms a projection, whereby when the insertion ends of the wires are inserted into the receiving compartment of the connector, the conductive engagement sections of the conductors of the wires are respectively positioned on the projections of the metal conductive elements.
